(19) United States
(12) Patent Application Publication
(10) Pub. No.: US 2008/0002301 A1
(43) Pub. Date: Jan. 3, 2008

(54) Head function evaluating apparatus and storage medium driving mechanism unit

(75) Inventors: Masanori Fukushi, Kawasaki (JP); Hiroshi Suzuki, Kawasaki (JP); Kazuhisa Mishima, Kawasaki (JP); Jungo Shimada, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, KAWASAKI (JP)

(21) Appl. No.: 11/896,845

(22) Filed: Sep. 6, 2007

Related U.S. Application Data
(63) Continuation of application No. PCT/JP05/04462, filed on Mar. 14, 2005.

(51) Int. Cl. G11B 5/48

(52) U.S. Cl. 360/240

(57) ABSTRACT

A head function evaluating apparatus designed to evaluate the function of a head. The apparatus allows the head to read out signals from a storage disk. The storage disk is mounted on a rotation shaft of a fluid bearing motor. The fluid bearing motor is employed to drive the storage disk for rotation. The fluid bearing motor is made smaller in size as compared with a so-called air spindle. In addition, the first and second flat surfaces are opposed to the front and back surfaces of the storage disk. The first and second flat surfaces serve to achieve so-called squeezing effect in the head function evaluating apparatus. This results in suppression of vibration of the rotating storage disk.

### BACKGROUND OF THE INVENTION

1. Field of the Invention

The present invention relates to ahead function evaluating apparatus designed to evaluate ahead, such as an electromagnetic transducer, incorporated in a storage medium drive such as a hard disk drive, HDD.

2. Description of the Prior Art

A head function evaluating apparatus is well known as disclosed in Japanese Patent Application Publication No. 2003-123356, for example. In the head function evaluating apparatus, a head suspension assembly including a head slider is held on a head suspension holding apparatus, for example. An electromagnetic transducer or magnetic head on the head slider is opposed to the surface of a rotating magnetic recording disk at a distance. The function of the magnetic head is evaluated based on signals read from the magnetic head.

The magnetic recording disk is mounted on a rotation shaft of an air spindle or air bearing spindle motor. The air bearing spindle motor utilizes air pressure to suppress runout or eccentricity of the rotation shaft during rotation of the magnetic recording disk. This results in suppression of vibration of the magnetic recording disk. However, since the spindle motor has a function of generating air pressure, the size of the spindle motor is inevitably increased.

### SUMMARY OF THE INVENTION

It is accordingly an object of the present invention to provide a storage medium driving mechanism unit capable of suppressing runout or eccentricity of a rotation shaft during rotation of a storage disk regardless of reduction in size. It is also an object of the present invention to provide a storage medium holding apparatus allowing an easier attachment and removal of a clamp to and from the rotation shaft. It is also an object of the present invention to provide a head suspension holding apparatus contributing to avoidance of damages to a head suspension assembly.

According to a first aspect of the present invention, there is provided a head function evaluating apparatus comprising: a stage; a head holding unit fixed on the stage to hold a head suspension; a carrier member located on the stage for relative movement to the head holding unit; a base removably fixed to the carrier member; a fluid bearing motor incorporated in the base; a cover coupled to the base through a hinge; a first flat surface formed on the base, the first flat surface seamlessly surrounding a rotation shaft of the fluid bearing motor; and a second flat surface formed on the cover in parallel with the first flat surface, the second flat surface seamlessly surrounding the rotation shaft of the fluid bearing motor at a position opposed to the first flat surface.

A storage disk is mounted on the rotation shaft of the fluid bearing motor in the head function evaluating apparatus. The fluid bearing motor is employed to drive the storage disk for rotation. The fluid bearing motor is made smaller in size as compared with a so-called air spindle. In addition, the first and second flat surfaces serve to achieve so-called squeezing effect in the head function evaluating apparatus. This results in suppression of vibration of the rotating storage disk. The head function evaluating apparatus thus reduces runout or eccentricity of the rotation shaft during rotation of the storage disk regardless of reduction in size of the head function evaluating apparatus.

A specific storage medium driving mechanism unit may be provided to realize the aforementioned head function evaluating apparatus. The specific storage medium driving mechanism unit may comprise: a base; a fluid bearing motor incorporated in the base; a cover coupled to the base through a hinge; a first flat surface formed on the base, the first flat surface seamlessly surrounding a rotation shaft of the fluid bearing motor; and a second flat surface formed on the cover in parallel with the first flat surface, the second flat surface seamlessly surrounding the rotation shaft of the fluid bearing motor at a position opposed to the first flat surface. Employment of the storage medium driving mechanism unit in the head function evaluating apparatus enables an easier removal of the storage medium driving mechanism unit. Even if the storage medium driving mechanism unit breaks down during use, the storage medium driving mechanism unit can thus be replaced in a facilitated manner. This results in a shortened discontinuance of the operation of the head function evaluating apparatus.

According to a second aspect of the present invention, there is provided a head function evaluating apparatus comprising: a stage; a head holding unit fixed on the stage to hold a head suspension; a carrier member located on the stage for relative movement to the head holding unit; a base removably fixed to the carrier member; a fluid bearing motor incorporated in the base; a flange formed on a rotation shaft of the fluid bearing motor, the flange extending outward in a radial direction from the rotation shaft; a clamp defining a cylindrical space having the generatrix parallel to the central axis of the rotation shaft for receiving the rotation shaft, the clamp received on the flange in the direction of the central axis of the rotation shaft; a contact body supported on the rotation shaft for relative movement in the radial direction from the central axis of the rotation shaft; and an elastic member exhibiting an elastic force urging the contact body outward in the radial direction, wherein the clamp has an inclined surface to receive the tip end of the contact body, the inclined surface getting farther from the central axis of the rotation shaft as the distance gets larger from the cylindrical space in the direction of the central axis of the rotation shaft.

When the clamp has been mounted on the rotation shaft, a storage disk is interposed between the flange on the rotation shaft and the clamp. The tip end of the contact body on the rotation shaft is urged against the inclined surface of the clamp. The inclined surface converts the thrust force of the contact body in the centrifugal direction into a driving force acting on the clamp in the downward direction. The clamp thus exhibits an urging force based on the elastic force of the elastic member. The urging force serves to prevent the storage disk from shifting around the rotation shaft during the rotation of the rotation shaft.

The clamp is moved away from the flange along the rotation shaft for removal. The inclined surface serves to force the contact body to retreat against the elastic force of the elastic member during the upward movement of the clamp. When the tip end of the contact body sufficiently retreats toward the central axis of the rotation shaft, the rotation shaft can simply be pulled out of the cylindrical space.

In addition, the clamp may define a cam surface contacting with the contact body during movement of the clamp so as to apply a thrust force to the contact body toward the central axis of the rotation shaft. The cam surface may be utilized to set the clamp on the rotation shaft. The cam surface serves to force the contact body to retreat against the elastic force of the elastic member. The rotation shaft can thus easily be received into the cylindrical space irrespective of the contact body in this manner. The clamp can smoothly be mounted on the rotation shaft.

The head function evaluating apparatus enables attachment and removal of the clamp through relative movement between the clamp and the rotation shaft. An operator is allowed to enjoy a simplified operation of attachment and removal of the clamp. It is possible to reduce the working time for replacement of the storage disk. This results in a shortened discontinuance of the operation of the head function evaluating apparatus. Moreover, the urging force of the clamp can appropriately be adjusted based on the adjustment of the elastic force of the elastic member. This results in prevention of distortion in the storage disk. In the case where a screw is utilized to fix a clamp to the rotation shaft in a conventional manner, the screw loosens during a long rotation of the storage disk unless the screw is strongly screwed. On the other hand, if the screw is strongly screwed, the storage disk suffers from distortion around the rotation shaft.

A specific storage medium holding apparatus may be provided to realize the aforementioned head function evaluating apparatus. The specific storage medium holding apparatus may comprise: a flange formed on a rotation shaft, the flange extending outward in the radial direction from the rotation shaft; a clamp defining a cylindrical space having the generatrix parallel to the central axis of the rotation shaft for receiving the rotation shaft, the clamp received on the flange in the direction of the central axis of the rotation shaft; a contact body supported on the rotation shaft for relative movement in the radial direction from the central axis of the rotation shaft; and an elastic member exhibiting an elastic force urging the contact body outward in the radial direction. In this case, the clamp may have an inclined surface to receive the tip end of the contact body, the inclined surface getting farther from the central axis of the rotation shaft as distance gets larger from the cylindrical space in the direction of the central axis of the rotation shaft. The inclined surface may define a truncated-cone-shaped space connected to one end of the cylindrical space, the truncated-cone-shaped space getting larger in the outward direction as distance gets larger from the cylindrical space.

According to a third aspect of the present invention, there is provided a head function evaluating apparatus comprising: a stage; an immobilized body fixed on the stage; a movable body coupled to the immobilized body for relative movement; a piezoelectric actuator interposed between the immobilized body and the movable body; a fixation mechanism enabling fixation of an attachment plate to the movable body, the attachment plate incorporated in a head suspension assembly at the supported end of a head suspension; a suction mechanism utilizing negative pressure to attract a head slider to the movable body, the head slider incorporated in the head suspension assembly at the tip end of the head suspension; a carrier member located on the stage for relative movement to the immobilized body; a base removably fixed to the carrier member; a fluid bearing motor incorporated in the base; and a cover coupled to the base through a hinge.

A storage disk is mounted on the rotation shaft of the fluid bearing motor in the head function evaluating apparatus. The fixation mechanism serves to fixedly hold the attachment plate at the supported end of the head suspension on the movable body. The piezoelectric actuator causes movement of the movable body. The head slider is accurately positioned relative to the storage disk in response to the movement of the movable body. The function of the head is evaluated in this manner.

When the evaluation has been completed, the suction mechanism acts on the head suspension. The head suspension is moved toward the movable body. The head slider is thus moved away from the surface of the storage disk. The carrier member thereafter serves to move the storage disk away from the head slider. Since the head slider is distanced from the storage disk based on the operation of the suction mechanism prior to the movement of the storage disk, contact/collision is reliably prevented between the rotating storage disk and the head slider. The head suspension is in this manner prevented from damages.

A specific head suspension holding apparatus may be provided to realize the aforementioned head function evaluating apparatus. The head suspension holding apparatus may comprise: an immobilized body; a movable body coupled to the immobilized body for relative movement; a piezoelectric actuator interposed between the immobilized body and the movable body; a fixation mechanism enabling fixation of an attachment plate to the movable body, the attachment plate incorporated in a head suspension assembly at a supported end of a head suspension; and a suction mechanism utilizing negative pressure to attract a head slider to the movable body, the head slider incorporated in the head suspension assembly at the tip end of the head suspension.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a head function evaluating apparatus, namely a spin stand;

FIG. 2 is a perspective view schematically illustrating a storage disk driving mechanism unit incorporated in the spin stand;

FIG. 3 is a perspective view schematically illustrating the storage disk driving mechanism unit;

FIG. 4 is an enlarged vertical sectional view schematically illustrating a storage disk holding apparatus related to the storage disk driving mechanism unit;

FIG. 5 is a graph showing the relationship between the flutter of the magnetic storage disk and the intervals or gaps between the surfaces of a magnetic storage disk and first and second flat surfaces; and

FIG. 6 is an enlarged plan view schematically illustrating the head holding unit incorporated in the spin stand.

### DESCRIPTION OF THE PREFERRED EMBODIMENT

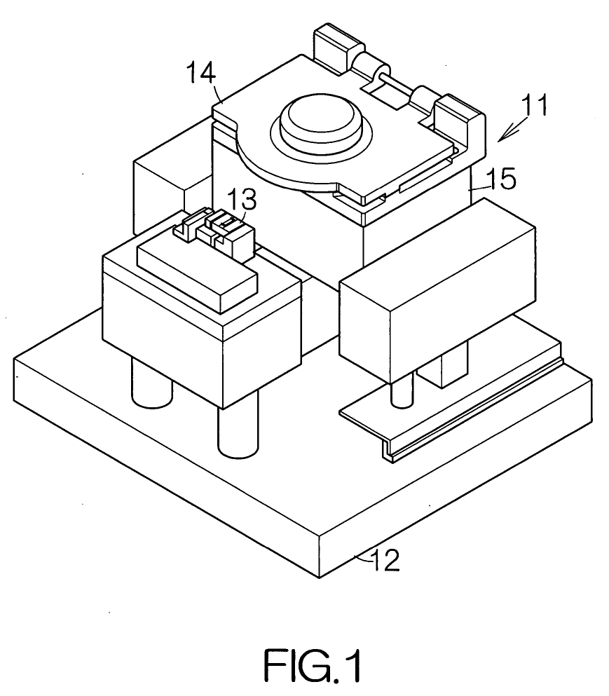

FIG. 1 schematically illustrates a head function evaluating apparatus, namely a spin stand 11. The spin stand 11 includes a stage 12 smaller than a conventional stage. A head holding unit 13 is fixed on the stage 12. The head holding unit 13 may be immobilized on the stage 12. The head holding unit 13 serves to hold a head suspension assembly incorporated in a hard disk drive, HDD, or the like, as described later in detail.

A storage disk driving mechanism unit 14 is set on the stage 12. A carrier member 15 is attached to the stage 12 to support the storage disk driving mechanism unit 14. The carrier member 15 is designed to move relative to the head holding unit 13. The storage disk driving mechanism unit 14 is removably fixed to the carrier member 15. A screw or screws maybe utilized to fix the storage disk driving mechanism unit 14, for example. The storage disk driving mechanism unit 14 is designed to drive a magnetic recording disk for rotation around a predetermined rotation axis as described later in detail.

A so-called head slider is incorporated in the head suspension assembly. An electromagnetic transducer or magnetic head is mounted on the head slider. The displacement of the storage disk driving mechanism unit 14 serves to oppose the magnetic head to the surface of the rotating magnetic recording disk at a distance. The function of the magnetic head is evaluated based on signals read from the magnetic head.

The spin stand 11 allows an easier removal of the storage disk driving mechanism unit 14 from the stage 12. Even if the storage disk driving mechanism unit 14 breaks down during use, the storage disk driving mechanism unit 14 can thus be replaced in a relatively facilitated manner. This results in a shortened discontinuance of the operation of the spin stand 11.

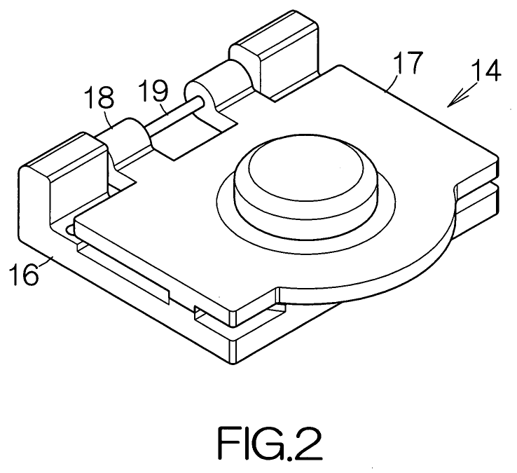

As shown in FIG. 2, the storage disk driving mechanism unit 14 includes a base 16 removably fixed to the carrier member 15. A cover 17 is superimposed on the surface of the base 16. A hinge 18 is employed to couple the cover 17 to the base 16. The hinge 18 includes a support shaft 19 extending in the horizontal direction. The cover 17 is thus allowed to rotate relative to the base 16 around the support shaft 19.

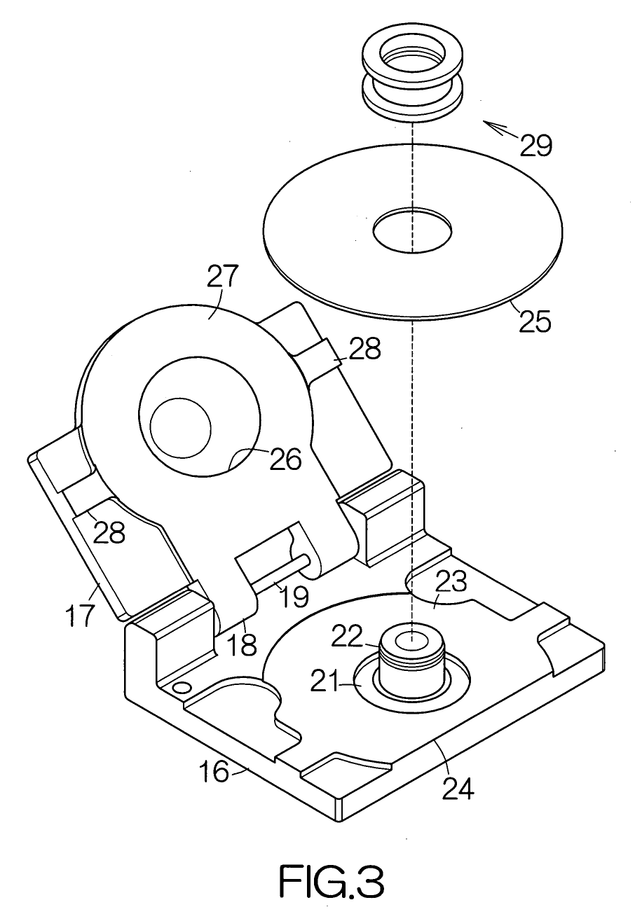

Referring also to FIG. 3, a spindle motor 21 is incorporated in the base 16. A fluid bearing motor is employed as the spindle motor 21. The fluid bearing motor may have the structure identical to the structure of a spindle motor incorporated in a hard disk drive or the like. Specifically, the fluid bearing motor includes a rotation shaft and a cylindrical member designed to receive the rotation shaft in a conventional manner. Fluid namely a lubricant fills the space between the rotation shaft and the cylindrical member in a well-known manner. The spindle motor 21 is capable of driving a rotation shaft 22 for rotation at a higher revolution speed in a range from 3,500 rpm to 15,000 rpm, for example.

An annular first flat surface 23 is formed in the surface of the base 16. The first flat surface 23 extends along a horizontal plane in parallel with the support shaft 19 of the hinge 18. The first flat surface 23 seamlessly or endlessly surrounds the rotation shaft 22 of the spindle motor 21. The inner and outer peripheries of the first flat surface 23 may respectively describe circles concentric to the rotation shaft 22. It should be noted that a cutout 24 is formed in the outer periphery of the first flat surface 23. The cutout 24 may be formed along a vertical plane parallel to not only the support shaft 19 of the hinge 18 but also the central axis of the rotation shaft 22. The head suspension assembly is positioned along the cutout 24 during the aforementioned evaluation. The interval between the inner and outer peripheries of the first flat surface 23 and/or the location of the first flat surface 23 may depend on the dimension of a magnetic recording disk 25 mounted on the rotation shaft 22, for example.

The cover 17 has an inside surface opposed to the surface of the base 16. A domed depression 26 is formed in the inside surface of the cover 17. When the cover 17 is superimposed on the surface of the base 16 with the assistance of the hinge 18, the tip end of the rotation shaft 22 of the spindle motor 21 is positioned within the domed depression 26.

An annular second flat surface 27 is formed in the inside surface of the cover 17. The second flat surface 27 is designed to extend along a plane in parallel with the support shaft 19 of the hinge 18. The second flat surface 27 seamlessly or endlessly surrounds the domed depression 26. The inner and outer peripheries of the second flat surface 27 may respectively describe concentric circles. When the cover 17 is superimposed on the surface of the base 16, the second flat surface 27 is opposed to the first flat surface 23. The first and second flat surfaces 23, 27 are set parallel to each other. The centers of the concentric circles are aligned with the central axis of the rotation shaft 22. The interval between the first and second flat surfaces 23, 27 may depend on the thickness of the magnetic recording disk 25 mounted on the rotation shaft 22, for example, as described later.

A pair of contact pieces 28 is fixed outside the second flat surface 27, for example. The contact pieces 28 may be integral with the cover 27 to form a one-piece component. When the cover 17 is superimposed on the surface of the base 16, the cover 17 is brought in contact with the surface of the base 16 at the contact pieces 28. Since the contact pieces 28 protrude from the second flat surface 26, the contact pieces 28 serves to establish the aforementioned interval between the first and second flat surfaces 23, 27 and the arrangement of the first and second flat surfaces 23, 27.

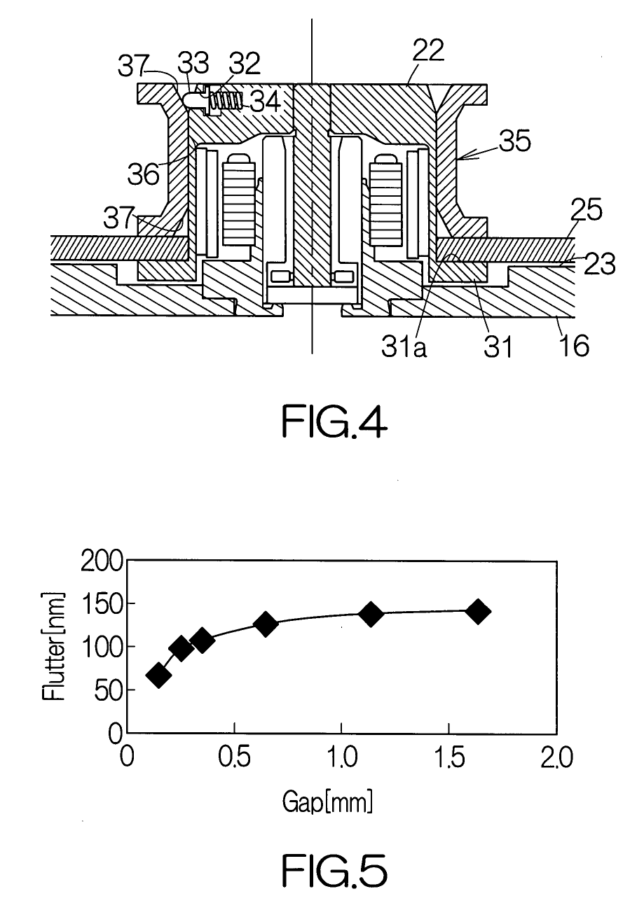

A storage disk holding apparatus 29 is related to the spindle motor 21. As shown in FIG. 4, the storage disk holding apparatus 29 includes a flange 31 formed on the rotation shaft 22. The flange 31 extends outward in the radial or centrifugal direction from the rotation shaft 22. The flange 31 defines an upper surface 31a. The upper surface 31a extends within a horizontal plane perpendicular to the central axis of the rotation shaft 22. The upper surface 31a is designed to receive the magnetic recording disk 25.

A radial bore 32 or radial bores 32 is formed in the rotation shaft 22. The radial bore 32 extends in the radial direction of the rotation shaft 22, for example. A contact body 33 is received in the radial bore 32 for relative movement in the radial direction. An elastic member, namely a coil spring 34, is interposed between the bottom of the radial bore 32 and the contact body 33. The coil spring 34 exhibits an elastic force urging the contact body 33 outward in the radial direction. The elastic force serves to protrude the tip end of the contact body 33 out of the radial bore 32. The tip end of the contact body 33 is formed into the shape of a dome, for example. The contact body 33 is in this manner supported on the rotation shaft 22. The radial bores 32 and contact bodies 33 may be located at two or more positions, three positions in this case, at even intervals around the central axis of the rotation shaft 22.

A clamp 35 is mounted on the rotation shaft 22. The clamp 35 defines a cylindrical space 36 for receiving the rotation shaft 22. The cylindrical space 36 has a generatrix parallel to the central axis of the rotation shaft 22. The cylindrical space 36 thus serves to guide the movement of the clamp 35 on the rotation shaft 22 in the direction of the central axis of the rotation shaft 22.

Inclined surfaces 37 are defined at the opposite ends of the cylindrical space 36, respectively. Each of the inclined surfaces 37 gets farther from the central axis of the rotation shaft 22 as the distance gets larger from the cylindrical space 36. The inclined surface 37 has generatrix inclined to the central axis of the rotation shaft 22 by a predetermined inclination angle, for example. The inclined surface 37 thus defines a truncated-cone-shaped space connected to one end of the cylindrical space 36. The truncated-cone-shaped space gets larger in the outward direction as the distance gets larger from the cylindrical space 36. The clamp 35 may be formed symmetric relative to a horizontal plane, for example.

When the clamp 35 is fully mounted on the rotation shaft 22, the magnetic recording disk 25 is interposed between the flange 31 on the rotation shaft 22 and the clamp 35. The back surface of the magnetic recording disk 25 is set in parallel with the first flat surface 23. The tip ends of the contact bodies 33 on the rotation shaft 22 are urged against the inclined surface 37 of the clamp 35. The inclined surface 37 converts the thrust force of the contact body 33 in the centrifugal direction into a driving force acting on the clamp 35 in the downward direction. The clamp 35 thus exhibits an urging force based on the elastic force of the spring 34. The urging force serves to prevent the magnetic recording disk 25 from shifting around the rotation shaft 22 during the rotation of the rotation shaft 22.

The clamp 35 is moved away from the flange 31 along the rotation shaft 22 for removal. Specifically, the clamp 35 is moved upward. The inclined surface 37 serves to force the contact body 33 to retreat against the elastic force of the spring 34 during the upward movement of the clamp 35. When the tip end of the contact body 33 sufficiently retreats toward the central axis of the rotation shaft 22, the rotation shaft 22 can simply be pulled out of the cylindrical space 36.

The inclined surface 37 first contacts with the tip ends of the contact bodies 33 for attachment of the clamp 35. When the rotation shaft 22 is pushed into the cylindrical space 26, the inclined surface 37 serves to force the contact body 33 to retreat against the elastic force of the spring 34. The rotation shaft 22 can easily be received into the cylindrical space 36 irrespective of the contact bodies 33 in this manner. The clamp 35 can smoothly be mounted on the rotation shaft 22. The movement of the clamp 35 is received on the flange 31 through the magnetic recording disk 25. In this case, the inclined surface 37 serves as a cam surface according to the present invention.

The storage disk holding apparatus 29 enables attachment and removal of the clamp 35 through relative movement between the clamp 35 and the rotation shaft 22. An operator is allowed to enjoy a simplified operation of attachment and removal of the clamp 35. It is possible to reduce the working time for replacement of the magnetic recording disk 25. This results in a shortened discontinuance of the operation of the spin stand 11. Moreover, the urging force of the clamp 35 can appropriately be adjusted based on the adjustment of the elastic force of the coil spring 34. This results in prevention of distortion in the magnetic recording disk 25. In the case where a screw is utilized to fix a clamp to the rotation shaft 22 in a conventional manner, the screw loosens during a long rotation of the magnetic recording disk 25 unless the screw is strongly screwed. However, if the screw is strongly screwed, the magnetic recording disk 25 suffers from distortion around the rotation shaft 22. This prevents establishment of a reduced flying height of a head slider.

The cover 17 is superimposed on the base 16 during the rotation of the magnetic recording disk 25 in the storage disk driving mechanism unit 14. The front surface of the magnetic recording disk 25 is opposed to the second flat surface 27, while the back surface of the magnetic recording disk 25 is opposed to the first flat surface 23. As is apparent from FIG. 5, for example, if the intervals between the magnetic recording disk 25 and the first and second flat surfaces 23, 27, respectively, are sufficiently narrowed, the magnetic recording disk 25 is allowed to enjoy a reduced flutter or vibration based on so-called squeezing effect. In particular, if the intervals between the magnetic recording disk 25 and the first and second flat surfaces 23, 27, respectively, are set smaller than 0.5 mm, the vibration is significantly suppressed as compared with the case where the intervals are set at 1.5 mm or more in a conventional manner.

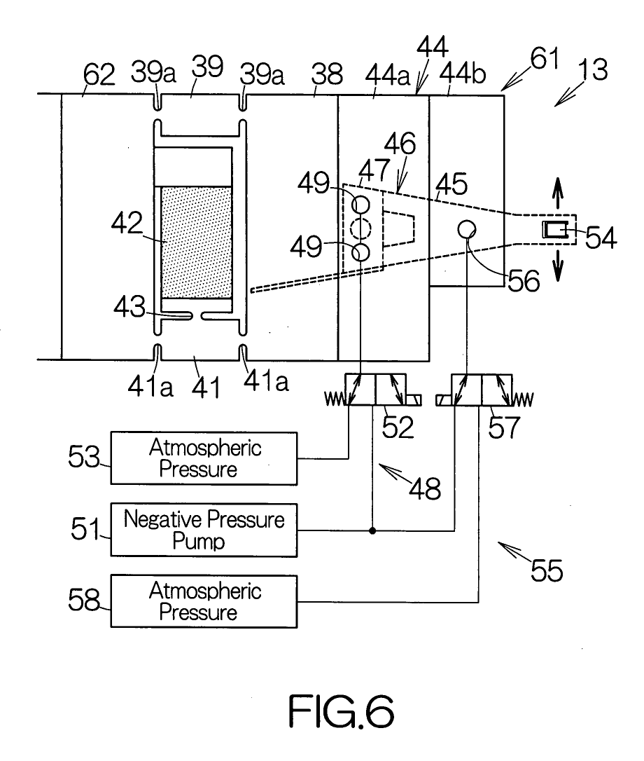

Next, a brief description will be made on the head holding unit 13. The head holding unit 13 includes a head suspension holding apparatus 61. As shown in FIG. 6, an immobilized body 62 is immobilized to the stage 12 in the head suspension holding apparatus 61. A movable body 38 is connected to the immobilized body 62. The movable body 38 and the immobilized body 62 are formed as a one-piece component. First and second connecting pieces 39, 41 are defined between the movable body 38 and the immobilized body 62. Narrow portions 39a, 41a are utilized to connect the first and second connecting pieces 39, 41 to the immobilized body 62 and the movable body 38. The immobilized body 62, the movable body 38 and the first and second connecting pieces 39, 41 in combination establish a four-piece linkage. The movable body 38 is designed to move in parallel with the immobilized body 62.

A piezoelectric actuator 42 is interposed between the immobilized body 62 and the movable body 38. One end of the piezoelectric actuator 42 is coupled to the immobilized body 62 at a position adjacent to the first connecting piece 39. The other end of the piezoelectric actuator 42 is coupled to the second connecting piece 41. A narrow section 43 is defined between the piezoelectric actuator 42 and the second connecting piece 41. The second connecting piece 41 is thus allowed to swing relative to the piezoelectric actuator 42.

In this case, the second connecting piece 41 swings relative to the immobilized body 62 in response to the elongation and shrinkage of the piezoelectric actuator 42 between the coupled ends of the piezoelectric actuator 42. This results in the movement of the movable body 38 in the direction of the elongation and shrinkage of the piezoelectric actuator 42. Specifically, the movable body 38 displaces in parallel with the immobilized body 62. The second connecting piece 42 serves to transmit an amplified elongation and shrinkage of the piezoelectric actuator 42 to the movable body 38.

A support member 44 is coupled to the movable body 38. The support member 44 includes a first support body 44a coupled to the movable body 38 and a second support body 44b coupled to the first support body 44a. A fixation mechanism 48 is incorporated in the first support body 44a. The fixation mechanism 48 is designed to fixedly hold an attachment plate 47 on the movable body 38. The attachment plate 47 is incorporated in the head suspension assembly 46 at the supported end of the head suspension 45. The fixation mechanism 48 may include a first air vent 49 formed in the first support body 44a and a negative pressure pump 51 connected to the first air vent 49, for example. When negative pressure is generated at the first air bent 49 based on the operation of the negative pressure pump 51, the suction serves to adsorb the attachment plate 47 on the first support body 44a. The supported end of the head suspension 45 is in this manner stationarily set on the first support body 44a. In this case, a solenoid valve 52 is disposed between the negative pressure pump 51 and the first air bent 49. The solenoid valve 52 is designed to change the connection between the first air vent 49 and the negative pressure pump 51 to the connection between the first air vent 49 and atmospheric pressure 53.

A suction mechanism 55 is incorporated in the second support body 44b. The suction mechanism 55 is designed to exert suction on the head slider 54 against the movable body 38 based on negative pressure. The head slider 54 is incorporated in the head suspension assembly 46 at the tip end of the head suspension 45. The suction mechanism 55 may include a second air vent 56 formed in the second support body 44b and the negative pressure pump 51 connected to the second air vent 56 in the same manner as the fixation mechanism 48, for example. When negative pressure is generated at the second air vent 56 based on the operation of the negative pressure pump 51, the suction serves to adsorb the head suspension 45 on the second support body 44b. The tip end of the head suspension 45 is in this manner adsorbed to the second support body 44b. In this case, a solenoid valve 57 is disposed between the negative pressure pump 51 and the second air vent 56. The solenoid valve 57 is designed to change the connection between the second air vent 56 and the negative pressure pump 51 to the connection between the second air vent 56 and atmospheric pressure 58. The suction mechanism 55 and the fixation mechanism 48 may share a common negative pressure pump. Alternatively, the suction mechanism 55 may employ its own negative pressure pump different from the negative pressure pump 51 of the fixation mechanism 48.

When the head suspension assembly 46 is placed on the support body 44, the fixation mechanism 48 serves to fixedly hold the attachment plate 47 of the head suspension assembly 46 on the first support body 44a. Wires for evaluation, not shown, are then connected to the head suspension assembly 46. In this case, air bearing surfaces of the head slider 54 face upward. The second air vent 56 is connected to the atmospheric pressure 58.

The storage disk driving mechanism unit 14 then gradually approaches the head holding unit 13. The rotating magnetic recording disk 25 is positioned above the head slider 54. The storage disk driving mechanism unit 14 then gradually moves downward. When the rotating magnetic recording disk 25 gets closer to the head slider 54, the air bearing surfaces of the head slider 54 gradually receives airflow generated along the magnetic recording disk 25. The air bearing is established between the head slider 54 and the surface of the magnetic recording disk 25 in this manner. The head slider 54 is allowed to keep flying at a predetermined height from the magnetic recording disk 25 by the balance between the urging force of the head suspension 45 and a positive pressure or lift generated on the head slider 54. The magnetic head on the head slider 54 realizes writing and reading operation of data during the flight of the head slider 54. The piezoelectric actuator 42 allows the magnetic head on the head slider 54 to keep following a target track on the magnetic recording disk 25. Evaluation of the function of the magnetic head is achieved in this manner.

When the evaluation has been completed, the suction mechanism 55 acts on the head suspension 45. The head suspension 45 is moved toward the second support body 44b. The head slider 54 is thus moved away from the surface of the magnetic recording disk 25. The carrier member 15 thereafter serves to move the storage disk driving mechanism unit 14 away from the head holding unit 13. The magnetic recording disk 25 is distanced from the head slider 54 in this manner. Since the head slider 54 is distanced from the magnetic recording disk 25 based on the operation of the suction mechanism 55 prior to the movement of the storage disk driving mechanism unit 14, contact/collision is reliably prevented between the rotating magnetic recording disk 25 and the head slider 54.

What is claimed is:

1. A head function evaluating apparatus comprising:
a stage;
a head holding unit fixed on the stage to hold a head suspension;
a carrier member located on the stage for relative movement to the head holding unit;
a base removably fixed to the carrier member;
a fluid bearing motor incorporated in the base;
a cover coupled to the base through a hinge;
a first flat surface formed on the base, the first flat surface seamlessly surrounding a rotation shaft of the fluid bearing motor; and
a second flat surface formed on the cover in parallel with the first flat surface, the second flat surface seamlessly surrounding the rotation shaft of the fluid bearing motor at a position opposed to the first flat surface.

2. A storage medium driving mechanism unit comprising:
a base;
a fluid bearing motor incorporated in the base;
a cover coupled to the base through a hinge;
a first flat surface formed on the base, the first flat surface seamlessly surrounding a rotation shaft of the fluid bearing motor; and
a second flat surface formed on the cover in parallel with the first flat surface, the second flat surface seamlessly surrounding the rotation shaft of the fluid bearing motor at a position opposed to the first flat surface.

3. A storage medium holding apparatus comprising:
a flange formed on a rotation shaft, the flange extending outward in a radial direction from the rotation shaft;
a clamp defining a cylindrical space having a generatrix parallel to a central axis of the rotation shaft for receiving the rotation shaft, the clamp received on the flange in a direction of the central axis of the rotation shaft;
a contact body supported on the rotation shaft for relative movement in the radial direction from the central axis of the rotation shaft; and
an elastic member exhibiting an elastic force urging the contact body outward in the radial direction, wherein the clamp has an inclined surface to receive a tip end of the contact body, the inclined surface getting farther from the central axis of the rotation shaft as distance gets larger from the cylindrical space in the direction of the central axis of the rotation shaft.

4. The storage medium holding apparatus according to claim 3, wherein the clamp defines a cam surface contacting with the contact body during movement of the clamp so as to apply a thrust force to the contact body toward the central axis of the rotation shaft.

5. The storage medium holding apparatus according to claim 3, wherein the inclined surface defines a truncated-cone-shaped space connected to one end of the cylindrical space, the truncated-cone-shaped space getting larger in an outward direction as distance gets larger from the cylindrical space.

6. A head function evaluating apparatus comprising:
a stage;
a head holding unit fixed on the stage to hold a head suspension;
a carrier member located on the stage for relative movement to the head holding unit;
a base removably fixed to the carrier member;
a fluid bearing motor incorporated in the base;
a flange formed on a rotation shaft of the fluid bearing motor, the flange extending outward in a radial direction from the rotation shaft;
a clamp defining a cylindrical space having a generatrix parallel to a central axis of the rotation shaft for receiving the rotation shaft, the clamp received on the flange in a direction of the central axis of the rotation shaft;
a contact body supported on the rotation shaft for relative movement in the radial direction from the central axis of the rotation shaft; and
an elastic member exhibiting an elastic force urging the contact body outward in the radial direction, wherein
the clamp has an inclined surface to receive a tip end of the contact body, the inclined surface getting farther from the central axis of the rotation shaft as distance gets larger from the cylindrical space in the direction of the central axis of the rotation shaft.

7. A head suspension holding apparatus comprising:
an immobilized body;
a movable body coupled to the immobilized body for relative movement;
a piezoelectric actuator interposed between the immobilized body and the movable body;
a fixation mechanism enabling fixation of an attachment plate to the movable body, the attachment plate incorporated in a head suspension assembly at a supported end of a head suspension; and
a suction mechanism utilizing negative pressure to attract a head slider to the movable body, the head slider incorporated in the head suspension assembly at a tip end of the head suspension.

8. A head function evaluating apparatus comprising:
a stage;
an immobilized body fixed on the stage;
a movable body coupled to the immobilized body for relative movement;
a piezoelectric actuator interposed between the immobilized body and the movable body;
a fixation mechanism enabling fixation of an attachment plate to the movable body, the attachment plate incorporated in a head suspension assembly at a supported end of a head suspension;
a suction mechanism utilizing negative pressure to attract a head slider to the movable body, the head slider incorporated in the head suspension assembly at a tip end of the head suspension;
a carrier member located on the stage for relative movement to the immobilized body;
a base removably fixed to the carrier member;
a fluid bearing motor incorporated in the base; and
a cover coupled to the base through a hinge.
